(19) United States
(12) Patent Application Publication
(10) Pub. No.: US 2026/0251096 A1
(43) Pub. Date: Aug. 27, 2026

(54) DUAL FUEL INJECTOR, DESIGN METHOD THEREFOR, AND INJECTION CONTROL METHOD THEREFOR

(71) Applicant: Weichai Power Co., Ltd., Weifang (CN)

(72) Inventors: Changhai MA, Weifang (CN); Zhijie Li, Weifang (CN); Junlong Liu, Weifang (CN); Xuepeng Wang, Weifang (CN); Yuncheng Gu, Weifang (CN); Kai Zheng, Weifang (CN); Xiaoxin Liu, Weifang (CN); Xiaoxiao Zeng, Weifang (CN)

(73) Assignee: Weichai Power Co., Ltd., Weifang (CN)

(21) Appl. No.: 19/425,390

(22) Filed: Dec. 18, 2025

(30) Foreign Application Priority Data
Feb. 27, 2025 (CN) 202510221088.8

(51) Int. Cl. F02D 19/06; F02M 55/00; F02M 61/18

(52) U.S. Cl. CPC F02D 19/0694; F02D 19/061; F02D 19/0642; F02M 55/008; F02M 61/1886; F02D 2200/06; F02D 2200/101

(57) ABSTRACT

Provided are a dual fuel injector, a design method therefor, and an injection control method therefor, relating to the technical field of engines. The dual fuel injector includes a fuel oil injection valve core, a fuel oil injection valve seat, and a gaseous fuel injection valve seat. The fuel oil injection valve seat is provided with a fuel oil injection channel, and the fuel oil injection valve seat is provided with a fuel oil injection hole. The gaseous fuel injection valve seat is sleeved outside the fuel oil injection valve seat. A gaseous fuel injection channel is formed between the fuel oil injection valve seat and the gaseous fuel injection valve seat, and the gaseous fuel injection channel includes a gaseous fuel injection cavity. An axis of the fuel oil injection hole is set at an included angle to a central axis of the dual fuel injector.

### CROSS-REFERENCE TO RELATED APPLICATION

This application claims priority to Chinese patent application No. 202510221088.8 filed with the China National Intellectual Property Administration (CNIPA) on Feb. 27, 2025, the disclosure of which is incorporated herein by reference in its entirety.

### TECHNICAL FIELD

The present disclosure relates to the technical field of engines and, in particular, to a dual fuel injector, a design method therefor, and an injection control method therefor.

### BACKGROUND

The existing dual fuel engine usually adopts a dual injector solution, in which one injector is used for injecting fuel oil and the other injector is used for injecting gaseous fuel. Combustion is achieved by igniting the gaseous fuel with the fuel oil, thereby achieving energy conservation and emission reduction. However, the injection control of the two injectors is difficult to synchronize, failing to achieve a better injection effect and a mixing effect. In response to this, a dual fuel injector is provided in the related art so that the functions of fuel oil injection and gaseous fuel injection are integrated into the same injector, thereby ensuring synchronous injection. However, the fuel oil injection structure and the gaseous fuel injection structure of the existing dual fuel injector are both multi-hole injection structures, and the direction of the injected fuel oil beam is parallel to the direction of the injected gaseous fuel beam, causing most of the injected gaseous fuel to be injected at the edge of the combustion chamber. After injection by the dual fuel injector, as the crankshaft rotates, the fuel oil and the gaseous fuel are mixed in the combustion chamber. However, the mixed fuel is relatively dispersed in the combustion chamber, and there is less fuel concentrated in the combustion chamber pit, resulting in a slow combustion speed, reduced thermal efficiency, and deteriorated emission performance. In addition, since the fuel oil beam and the gaseous fuel beam are injected in parallel, the distance between the fuel oil beam and the gaseous fuel beam is relatively large, resulting in a relatively poor ignition effect of the fuel oil on the gaseous fuel and reduced thermal efficiency.

### SUMMARY

The present disclosure provides a dual fuel injector, a design method therefor, and an injection control method therefor to solve the problems of low thermal efficiency and deteriorated emission performance caused by the structure of the existing dual fuel injector.

The present disclosure provides a dual fuel injector. The dual fuel injector includes a fuel oil injection valve core, a fuel oil injection valve seat, and a gaseous fuel injection valve seat.

The fuel oil injection valve seat is provided with a fuel oil injection channel, the fuel oil injection valve core is disposed in the fuel oil injection channel, the fuel oil injection valve core is movable relative to the fuel oil injection valve seat to open or close the fuel oil injection channel, the fuel oil injection valve seat is provided with a fuel oil injection hole, and the fuel oil injection hole is in communication with the fuel oil injection channel and is used for injecting fuel oil into a combustion chamber.

The gaseous fuel injection valve seat is sleeved outside the fuel oil injection valve seat, a gaseous fuel injection channel is formed between the fuel oil injection valve seat and the gaseous fuel injection valve seat, the gaseous fuel injection channel includes a regulation cavity and a gaseous fuel injection cavity, the opening degree of the regulation cavity increases or decreases as the fuel oil injection valve seat rises or falls relative to the gaseous fuel injection valve seat, and the gaseous fuel injection cavity is used for injecting gaseous fuel into the combustion chamber.

The axis of the fuel oil injection hole is set at an included angle to the central axis of the dual fuel injector, and along the flow direction of the gaseous fuel, the extension direction of the gaseous fuel injection cavity is parallel to the central axis or inclined toward the central axis.

In one or more embodiments, the gaseous fuel injection channel further includes a pressure stabilization cavity, and the regulation cavity is in communication with the gaseous fuel injection cavity through the pressure stabilization cavity.

In one or more embodiments, the maximum width of the regulation cavity is greater than or equal to the width of the gaseous fuel injection cavity.

In one or more embodiments, along the direction of the central axis, the length of the gaseous fuel injection cavity is greater than the length of the pressure stabilization cavity, and the length of the pressure stabilization cavity is greater than the length of the regulation cavity.

In one or more embodiments, along the flow direction of the gaseous fuel, the gaseous fuel injection cavity is provided with an inlet section, an acceleration section, and an injection section in sequence, the inlet section has a bell-mouth structure, the large end of the inlet section is in communication with the pressure stabilization cavity, the acceleration section is in communication with the small end of the inlet section, a side of the injection section on the gaseous fuel injection valve seat is configured to be a straight wall, a side of the injection section on the fuel oil injection valve seat is configured to be an inclined wall, and the inclined wall is inclined toward the central axis.

In one or more embodiments, the included angle between the inclined wall of the injection section on the fuel oil injection valve seat and the horizontal direction is less than 60°.

In one or more embodiments, a side of the pressure stabilization cavity on the fuel oil injection valve seat is configured to be a straight wall, the upper section of a side of the pressure stabilization cavity on the gaseous fuel injection valve seat is configured to be a straight wall, the lower section of the side of the pressure stabilization cavity on the gaseous fuel injection valve seat is configured to be an inclined wall and extends downward to form an inclined wall of the inlet section on the gaseous fuel injection valve seat, and the included angle between an inclined wall of the inlet section on the fuel oil injection valve seat and the horizontal direction is greater than the included angle between the inclined wall of the inlet section on the gaseous fuel injection valve seat and the horizontal direction.

In one or more embodiments, the included angle between the inclined wall of the inlet section on the fuel oil injection valve seat and the horizontal direction is greater than or equal to 45° and less than or equal to 60°, and the included angle between the inclined wall of the inlet section on the gaseous fuel injection valve seat and the horizontal direction is greater than or equal to 45° and less than or equal to 60°.

The present disclosure provides a design method for a dual fuel injector, which is configured to perform a structural design on the dual fuel injector in any one of the preceding solutions. The design method for a dual fuel injector includes the steps below.

A simulation model of the dual fuel injector is established.

The number of fuel oil injection holes and/or the diameter of the fuel oil injection hole is adjusted so that the penetration distance of the fuel oil is within a first preset range.

The width of the gaseous fuel injection channel is adjusted so that the penetration distance of the gaseous fuel is within a second preset range.

The included angle between the axis of the fuel oil injection hole and the central axis is adjusted according to the ignition effect of the fuel oil on the gaseous fuel.

In one or more embodiments, a method for adjusting the number and diameter of fuel oil injection holes includes the steps below: When the penetration distance of the fuel oil is less than the minimum value of the first preset range, the number of fuel oil injection holes is reduced and/or the diameter of the fuel oil injection hole is reduced until the penetration distance of the fuel oil is within the first preset range; When the penetration distance of the fuel oil is greater than the maximum value of the first preset range, the number of fuel oil injection holes is increased and/or the diameter of the fuel oil injection hole is increased until the penetration distance of the fuel oil is within the first preset range.

In one or more embodiments, a method for adjusting the width of the gaseous fuel injection channel includes the steps below: When the penetration distance of the gaseous fuel is less than the minimum value of the second preset range, the width of the gaseous fuel injection channel is reduced until the penetration distance of the gaseous fuel is within the second preset range; When the penetration distance of the gaseous fuel is greater than the maximum value of the second preset range, the width of the gaseous fuel injection channel is increased until the penetration distance of the gaseous fuel is within the second preset range.

In one or more embodiments, the adjustment range of the included angle between the axis of the fuel oil injection hole and the central axis is 10° to 45°.

The present disclosure provides an injection control method for a dual fuel injector, which is applied to the dual fuel injector in the preceding solutions. The injection control method for a dual fuel injector includes the steps below.

The required gaseous fuel flow rate is calculated according to the required gaseous fuel intake volume and the rotational speed of an engine.

According to the correspondence between the movement distance of the fuel oil injection valve seat relative to the gaseous fuel injection valve seat in the dual fuel injector and the gaseous fuel flow rate, the movement distance of the fuel oil injection valve seat relative to the gaseous fuel injection valve seat is determined.

### BRIEF DESCRIPTION OF DRAWINGS

FIG. 1 is a sectional view of a dual fuel injector in a closed state according to an embodiment of the present disclosure.

FIG. 2 is a sectional view of a dual fuel injector in a fuel oil injection state according to an embodiment of the present disclosure.

FIG. 3 is a sectional view of a dual fuel injector in a gaseous fuel injection state according to an embodiment of the present disclosure.

FIG. 4 is a sectional view of a dual fuel injector in a state where gaseous fuel and fuel oil are injected simultaneously according to an embodiment of the present disclosure.

FIG. 5 is a structural view of a gaseous fuel injection channel according to an embodiment of the present disclosure.

FIG. 6 is a schematic view illustrating the geometric parameters of a gaseous fuel injection channel according to an embodiment of the present disclosure.

FIG. 7 is a schematic view illustrating the geometric parameters of a pressure stabilization cavity according to an embodiment of the present disclosure.

FIG. 8 is a schematic view illustrating a gas flow path in a pressure stabilization cavity according to an embodiment of the present disclosure.

FIG. 9 is a graph of a relationship curve between the lift and the gaseous fuel intake flow rate according to an embodiment of the present disclosure.

FIG. 10 is a flowchart of a design method for a dual fuel injector according to an embodiment of the present disclosure.

FIG. 11 is a flowchart of an injection control method for a dual fuel injector according to an embodiment of the present disclosure.

FIG. 12 is a sectional view of a dual fuel injector in a closed state according to an embodiment of the present disclosure.

### REFERENCE LIST

100 dual fuel injector
1 fuel oil injection valve core
2 fuel oil injection valve seat
3 gaseous fuel injection valve seat
4 combustion chamber
10 fuel oil injection hole
20 gaseous fuel injection channel
30 fuel oil injection channel 30
21 gaseous fuel supply cavity
22 regulation cavity
23 pressure stabilization cavity
24 gaseous fuel injection cavity
241 inlet section
242 acceleration section
243 injection section

### DETAILED DESCRIPTION

The technical solutions of the present disclosure are described clearly and completely below in conjunction with the drawings. Apparently, the described embodiments are part, not all, of the embodiments of the present disclosure. Based on the embodiments of the present disclosure, all other embodiments obtained by those of ordinary skill in the art are within the scope of the present disclosure on the premise that no creative work is done.

In the description of the present disclosure, it is to be noted that orientations or position relations indicated by terms such as “center”, “upper”, “lower”, “left”, “right”, “vertical”, “horizontal”, “inner”, and “outer” are based on the drawings. These orientations or position relations are intended only to facilitate and simplify the description of the present disclosure and not to indicate or imply that a device or element referred to must have such particular orientations or must be configured or operated in such particular orientations. Thus, these orientations or position relations are not to be construed as limiting the present disclosure. In addition, terms such as “first” and “second” are used for the purpose of description and are not to be construed as indicating or implying relative importance. Terms “first position” and “second position” are two different positions. Moreover, when a first feature is described as “on”, “above”, or “over” a second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of the present disclosure, it is to be noted that the term “mounted”, “connected to each other”, or “connected” should be construed in a broad sense unless otherwise expressly specified and limited. For example, the term “connected” may refer to “fixedly connected”, “detachably connected”, or “integrated”, may refer to “mechanically connected” or “electrically connected”, or may refer to “connected directly”, “connected indirectly through an intermediary”, or “connected inside two elements”. For those of ordinary skill in the art, specific meanings of the preceding terms in the present disclosure may be understood based on specific situations.

Embodiments of the present disclosure are described in detail below. Examples of the embodiments are illustrated in the drawings, where the same or similar reference numerals throughout the drawings represent the same or similar elements or elements having the same or similar functions. The embodiments described below with reference to the drawings are illustrative and intended only to explain the present disclosure and cannot be construed as limiting the present disclosure.

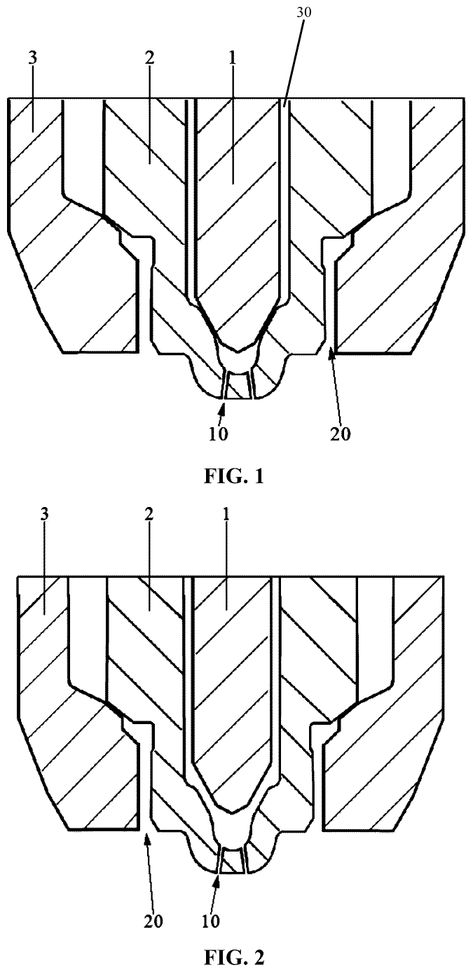

As shown in FIGS. 1 to 9 and 12, the present disclosure provides a dual fuel injector 100 and the dual fuel injector 100 is mounted on a cylinder head of an engine and is used for injecting fuel oil and/or gaseous fuel into a combustion chamber 4. The dual fuel injector 100 includes a fuel oil injection valve core 1, a fuel oil injection valve seat 2, and a gaseous fuel injection valve seat 3. The fuel oil injection valve seat 2 is provided with a fuel oil injection channel 30, the fuel oil injection valve core 1 is disposed in the fuel oil injection channel 30, the fuel oil injection valve core 1 is movable relative to the fuel oil injection valve seat 2 to open or close the fuel oil injection channel 30, the fuel oil injection valve seat 2 is provided with a fuel oil injection hole 10, and the fuel oil injection hole 10 is in communication with the fuel oil injection channel 30 and is used for injecting fuel oil into the combustion chamber 4. The gaseous fuel injection valve seat 3 is sleeved outside the fuel oil injection valve seat 2, and a gaseous fuel injection channel 20 is formed between the fuel oil injection valve seat 2 and the gaseous fuel injection valve seat 3. The fuel oil injection valve seat 2 is movable relative to the gaseous fuel injection valve seat 3 to increase or decrease the width of the gaseous fuel injection channel 20. The gaseous fuel injection channel 20 includes a gaseous fuel injection cavity 24 for injecting gaseous fuel into the combustion chamber 4. The fuel oil injection valve seat 2 and the gaseous fuel injection valve seat 3 are both cylindrical structures and are coaxially arranged. A gap exists between the outer side of the fuel oil injection valve seat 2 and the inner side of the gaseous fuel injection valve seat 3. The gap is the gaseous fuel injection channel 20. Moreover, as the fuel oil injection valve seat 2 moves relative to the gaseous fuel injection valve seat 3, a local gap between the fuel oil injection valve seat 2 and the gaseous fuel injection valve seat 3 increases or decreases, thereby increasing or decreasing the width of the gaseous fuel injection channel 20. The gaseous fuel injection cavity 24 is located at one end adjacent to the combustion chamber 4 so that the cross section of the position where the gaseous fuel is injected from the gaseous fuel injection channel 20 is annular, thereby achieving more uniform injection of the gaseous fuel and more uniform combustion. In addition, the axis of the fuel oil injection hole 10 is set at an included angle to the central axis of the dual fuel injector 100, and along the flow direction of the gaseous fuel, the extension direction of the gaseous fuel injection cavity 24 is parallel to the central axis or inclined toward the central axis. The extension direction of the gaseous fuel injection cavity 24 is parallel to or inclined toward the central axis of the dual fuel injector 100 so that more gaseous fuel is injected into the combustion chamber pit, thereby increasing the combustion speed. In this manner, emission performance deterioration can be avoided while the thermal efficiency is improved. In an embodiment, when the extension direction of the gaseous fuel injection cavity 24 is inclined relative to the central axis, the included angle between the gaseous fuel injection cavity 24 and the central axis is less than or equal to 15°, thereby ensuring that the wall thickness of the fuel oil injection valve seat 2 satisfies the requirements for the fuel oil injection pressure and the gaseous fuel injection pressure. For ease of description and understanding, this embodiment is described assuming that the extension direction of the gaseous fuel injection cavity 24 is parallel to the central axis. The axis of the fuel oil injection hole 10 is set at an included angle to the central axis of the dual fuel injector 100 so that the distance between the fuel oil and the gaseous fuel is closer, and the fuel oil can ignite the gaseous fuel more quickly, thereby improving the thermal efficiency. In the dual fuel injector 100 in this embodiment, the gaseous fuel injected into the combustion chamber 4 can be concentrated as much as possible and evenly distributed in the combustion chamber pit, and the distance between the fuel oil and the gaseous fuel can be shortened so that the fuel oil can ignite the gaseous fuel more quickly, the combustion speed of the gaseous fuel can be increased, and uniform combustion of the gaseous fuel in the combustion chamber 4 can be ensured, thereby avoiding emission performance deterioration and reducing engine vibrations while improving the thermal efficiency.

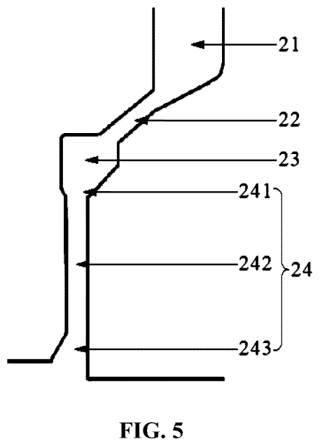

In one or more embodiments, as shown in FIGS. 5 to 8, the gaseous fuel injection channel 20 is further provided with a gaseous fuel supply cavity 21, a regulation cavity 22, and a pressure stabilization cavity 23. The gaseous fuel supply cavity 21, the regulation cavity 22, the pressure stabilization cavity 23, and the gaseous fuel injection cavity 24 are in communication with each other. The gaseous fuel supply cavity 21, the regulation cavity 22, the pressure stabilization cavity 23, and the gaseous fuel injection cavity 24 are arranged in sequence along the flow direction of the gaseous fuel. The gaseous fuel supply cavity 21 is configured to be in communication with a gaseous fuel tank, and the width of the regulation cavity 22 increases or decreases as the fuel oil injection valve seat 2 rises or falls relative to the gaseous fuel injection valve seat 3. The increase or decrease in the width of the regulation cavity 22 directly determines the flow rate of the gaseous fuel in the regulation cavity 22, thereby determining the amount of gaseous fuel entering the pressure stabilization cavity 23 and thus achieving the regulation of the flow rate of the gaseous fuel injected through the gaseous fuel injection cavity 24.

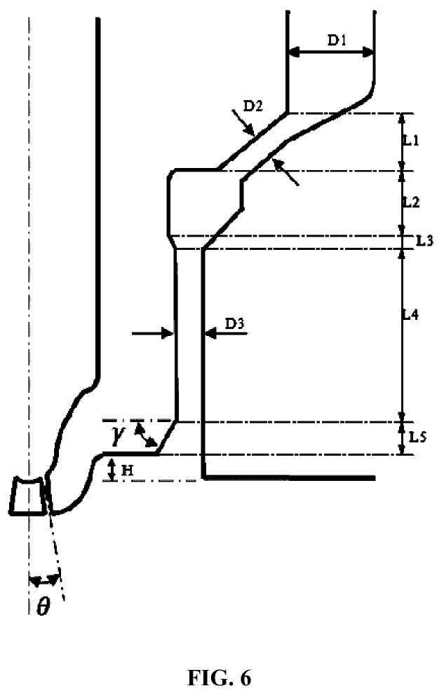

In one or more embodiments, referring to FIGS. 5 and 6, it is assumed that the width of the gaseous fuel supply cavity 21 is D1, the width of the regulation cavity 22 is D2, and the width of the gaseous fuel injection cavity 24 is D3. It is to be understood that the width of the regulation cavity 22 varies with the movement of the fuel oil injection valve seat 2, so the value of D2 is variable, and the maximum value of D2 is the width corresponding to the case where the fuel oil injection valve seat 2 moves to the upper limit position. Correspondingly, in this embodiment, the width of the gaseous fuel supply cavity 21 is configured to be greater than the maximum width of the regulation cavity 22, that is, D1>D2max, thereby ensuring that the supply of gaseous fuel is not limited by the width of the gaseous fuel supply cavity 21. Moreover, the maximum width of the regulation cavity 22 is greater than or equal to the width of the gaseous fuel injection cavity 24, that is, D2max≥D3 so that it is ensured that the gaseous fuel is not decelerated by the gaseous fuel injection cavity 24 after passing through the gaseous fuel injection cavity 24, thereby ensuring the penetration distance of the gaseous fuel.

In addition, referring to FIGS. 5 and 6, along the direction of the central axis of the dual fuel injector 100, the length of the gaseous fuel injection cavity 24 is greater than the length of the pressure stabilization cavity 23, and the length of the pressure stabilization cavity 23 is greater than the length of the regulation cavity 22. By providing the pressure stabilization cavity 23, a buffer is provided between the regulation cavity 22 and the gaseous fuel injection cavity 24. When the width of the gaseous fuel injection cavity 24 changes, the gaseous fuel flow rate changes accordingly. In this case, the pressure stabilization cavity 23 can prevent the gaseous fuel in the regulation cavity 22 from impacting the gaseous fuel injection cavity 24, thereby ensuring the stability of the gaseous fuel injected from the gaseous fuel injection cavity 24 and reducing fluctuations in pressure and flow velocity. The length of the gaseous fuel injection cavity 24 is configured to be greater than the length of the pressure stabilization cavity 23, thereby further ensuring the flow state of the gaseous fuel after flowing through the gaseous fuel injection cavity 24 and further ensuring the gaseous fuel injection stability. Moreover, the length of the pressure stabilization cavity 23 is configured to be greater than the length of the regulation cavity 22 so that after the gaseous fuel in the regulation cavity 22 enters the pressure stabilization cavity 23, the pressure stabilization cavity 23 can provide the gaseous fuel with a sufficient buffer space to further avoid the impact.

In one or more embodiments, as shown in FIG. 5, along the flow direction of the gaseous fuel, the gaseous fuel injection cavity 24 is provided with an inlet section 241, an acceleration section 242, and an injection section 243 in sequence, and the inlet section 241, the acceleration section 242, and the injection section 243 are connected end to end in sequence. The inlet section 241 has a bell-mouth structure, the large end of the inlet section 241 is in communication with the pressure stabilization cavity 23, and the acceleration section 242 is in communication with the small end of the inlet section 241. A side of the injection section 243 on the gaseous fuel injection valve seat 3 is configured to be a straight wall, a side of the injection section 243 on the fuel oil injection valve seat 2 is configured to be an inclined wall, and the inclined wall is inclined toward the central axis. Part of the gaseous fuel injected from the injection section 243 moves toward the central axis under the guidance of the inclined wall, thereby further improving the concentration degree of the gaseous fuel in the combustion chamber pit. As shown in FIG. 6, assuming that the included angle between the inclined wall of the injection section 243 on the fuel oil injection valve seat 2 and the horizontal direction is γ, then γ is less than 60°. Within this range, the penetration distance of the gaseous fuel injected from the injection section 243 is not significantly affected. As shown in FIG. 6, along the direction of the central axis of the dual fuel injector 100, assuming that the length of the regulation cavity 22 is L1, the length of the pressure stabilization cavity 23 is L2, the length of the inlet section 241 of the gaseous fuel injection cavity 24 is L3, the length of the acceleration section 242 of the gaseous fuel injection cavity 24 is L4, and the length of the injection section 243 of the gaseous fuel injection cavity 24 is L5, then L4>L2>L1>L5≥L3. The inlet section 241, the acceleration section 242, and the injection section 243 together form a Venturi structure, thereby accelerating the gaseous fuel to increase the penetration distance of the gaseous fuel. In this manner, the width of the regulation cavity 22 can be appropriately reduced while ensuring that the penetration distance of the gaseous fuel satisfies the requirements. The width D2 of the regulation cavity 22 depends on the distance that the fuel oil injection valve seat 2 moves relative to the gaseous fuel injection valve seat 3, that is, the lift of the fuel oil injection valve seat 2. As shown in FIG. 6, assuming that the lift of the fuel oil injection valve seat 2 is H, H is positively correlated with D2. The larger the lift H is, the lower the control accuracy and response speed are. Therefore, by setting the gaseous fuel injection cavity 24 as a Venturi structure to accelerate the gaseous fuel, the penetration distance requirement for the injected gaseous fuel can be satisfied with a smaller lift, thereby improving the control accuracy and response speed.

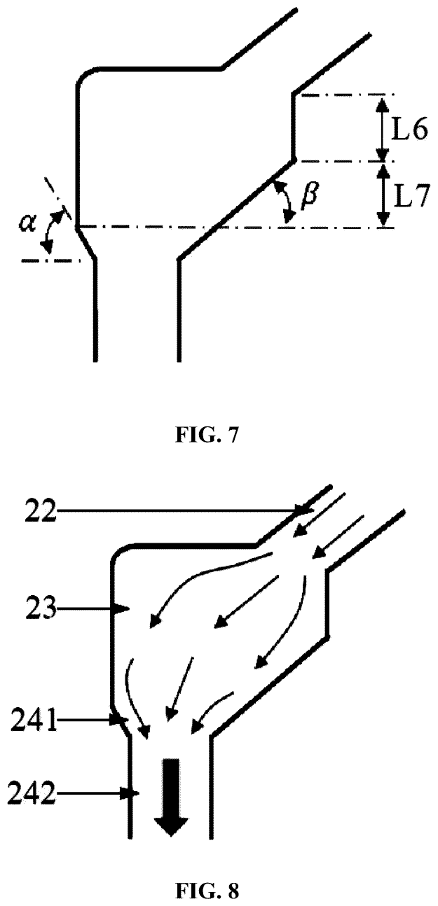

In one or more embodiments, a side of the pressure stabilization cavity 23 on the fuel oil injection valve seat 2 is configured to be a straight wall, the upper section of a side of the pressure stabilization cavity 23 on the gaseous fuel injection valve seat 3 is configured to be a straight wall, and the lower section of the side of the pressure stabilization cavity 23 on the gaseous fuel injection valve seat 3 is configured to be an inclined wall and extends downward to form an inclined wall of the inlet section 241 on the gaseous fuel injection valve seat 3. That is, the included angle between the inclined wall (the lower section of the side of the pressure stabilization cavity 23 on the gaseous fuel injection valve seat 3) and the horizontal direction is equal to the included angle between the inclined wall of the inlet section 241 of the gaseous fuel injection cavity 24 on the gaseous fuel injection valve seat 3 and the horizontal direction. In this embodiment, as shown in FIG. 7, the included angle is set to β. Correspondingly, the included angle between an inclined wall of the inlet section 241 of the gaseous fuel injection cavity 24 on the fuel oil injection valve seat 2 and the horizontal direction is set to α, and α is greater than β, that is, the included angle between the inclined wall of the inlet section 241 on the fuel oil injection valve seat 2 and the horizontal direction is greater than the included angle between the inclined wall of the inlet section 241 on the gaseous fuel injection valve seat 3 and the horizontal direction. In this manner, the process of gaseous fuel entering the gaseous fuel injection cavity 24 from the pressure stabilization cavity 23 can be smoother. The schematic view of the path on which the gaseous fuel flows from the regulation cavity 22 into the pressure stabilization cavity 23 and then into the gaseous fuel injection cavity 24 is shown in FIG. 8. The included angle between the inclined wall of the inlet section 241 on the fuel oil injection valve seat 2 and the horizontal direction is greater than or equal to 45° and less than or equal to 60°, that is, the included angle α shown in FIG. 7 satisfies 45°≤α≤60 °. The included angle between the inclined wall of the inlet section 241 on the gaseous fuel injection valve seat 3 and the horizontal direction is greater than or equal to 45° and less than or equal to 60°, that is, the included angle β shown in FIG. 7 satisfies 45°≤β≤60°. In conjunction with α>β, then 45°≤β<α≤60°. When the value of α and/or the value of β is too small, the gaseous fuel injection cavity 24 cannot effectively accelerate the gaseous fuel; and when the value of α and/or the value of β is too large, velocity separation of the gaseous fuel in the acceleration section 242 of the gaseous fuel injection cavity 24 easily occurs, affecting the injection effect.

It has been verified that compared with the engine using the dual fuel injector in the related art, the indicated thermal efficiency of the dual fuel engine using the dual fuel injector in this embodiment is improved from 51.6% to 53.4%, and the methane emissions are optimized from 0.018 g/kW·h to 0.006 g/kW·h.

FIG. 10 is a flowchart of a design method for a dual fuel injector according to an embodiment of the present disclosure. The design method for a dual fuel injector 100 is configured to perform a structural design on the dual fuel injector 100 in this embodiment. With reference to FIG. 10, the design method for a dual fuel injector 100 includes S102 to S108.

In S102, a simulation model of the dual fuel injector 100 is established.

In S104, the number of fuel oil injection holes 10 and/or the diameter of the fuel oil injection hole 10 is adjusted, and the simulation model is simulated so that the penetration distance of the fuel oil is within a first preset range.

In S106, the width of the gaseous fuel injection channel 20 is adjusted and the simulation model is simulated so that the penetration distance of the gaseous fuel is within a second preset range.

In S108, the included angle between the axis of the fuel oil injection hole 10 and the central axis is adjusted according to the ignition effect of the fuel oil on the gaseous fuel.

It is to be noted that the first preset range and the second preset range are determined according to the specific structure and dimension of the combustion chamber 4. During the design process, different first preset ranges and second preset ranges may be determined according to the combustion chambers 4 of different engine models. The first preset range and the second preset range are not specifically limited here. The ignition effect of the fuel oil on the gaseous fuel is evaluated by those skilled in the art according to actual engineering requirements and engine characteristics. The evaluation indicators include, but are not limited to, the fuel oil injection impact point, the fuel oil compression ignition timing, the position and range in which fuel oil ignites gaseous fuel, and the like. The selection of evaluation indicators and judgment conditions all belong to the related art, and the details are not repeated here.

In the design method for a dual fuel injector 100 in this embodiment, the number of the fuel oil injection holes and the diameter of the fuel oil injection hole 10 are adjusted so that the penetration distance of the fuel oil is within the first preset range. The width of the gaseous fuel injection channel 20 is adjusted so that the penetration distance of the gaseous fuel is within the second preset range. The included angle between the axis of the fuel oil injection hole 10 and the central axis is adjusted so that the fuel oil can ignite the gaseous fuel more quickly, thereby improving the thermal efficiency. Moreover, the dual fuel injector 100 is designed in this method so that the dual fuel injector 100 can be applied to combustion chambers 4 of different structures and dimensions.

In one or more embodiments, the method for adjusting the number and diameter of fuel oil injection holes 10 includes the steps below.

The first preset range is determined according to the specific structure of the combustion chamber 4 and the dual fuel injector 100 is simulated.

When the penetration distance of the fuel oil is less than the minimum value of the first preset range, the number of fuel oil injection holes 10 is reduced and/or the diameter of the fuel oil injection hole 10 is reduced until the penetration distance of the fuel oil is within the first preset range.

When the penetration distance of the fuel oil is greater than the maximum value of the first preset range, the number of fuel oil injection holes 10 is increased and/or the diameter of the fuel oil injection hole 10 is increased until the penetration distance of the fuel oil is within the first preset range.

In one or more embodiments, the method for adjusting the width of the gaseous fuel injection channel 20 includes the steps below.

The second preset range is determined according to the specific structure of the combustion chamber 4 and the dual fuel injector 100 is simulated.

When the penetration distance of the gaseous fuel is less than the minimum value of the second preset range, the width of the gaseous fuel injection channel 20 is reduced until the penetration distance of the gaseous fuel is within the second preset range.

When the penetration distance of the gaseous fuel is greater than the maximum value of the second preset range, the width of the gaseous fuel injection channel 20 is increased until the penetration distance of the gaseous fuel is within the second preset range.

It is to be noted that in this embodiment, the width of the gaseous fuel injection channel 20 is increased or decreased as a whole, and the widths of the gaseous fuel supply cavity 21, the pressure stabilization cavity 23, and the gaseous fuel injection cavity 24 are increased or decreased synchronously in proportion to avoid affecting other parameters while changing the penetration distance of the gaseous fuel. The width of the gaseous fuel injection channel 20 is a structural parameter of the dual fuel injector 100 and does not change with variations in the opening degree of the gaseous fuel injection channel 20. In addition, it is to be noted that the gaseous fuel injection cavity 24 includes the inlet section 241, the acceleration section 242, and the injection section 243, and the acceleration section 242 is the main part and is the section that has a significant impact on the penetration distance of the gaseous fuel. Therefore, the change in the width of the gaseous fuel injection cavity 24 is mainly the change in the width of the acceleration section 242, and the corresponding angles of the inlet section 241 and the injection section 243 may remain unchanged or be adaptively adjusted within a preset range to ensure a good gaseous fuel injection state.

In one or more embodiments, referring to FIG. 7, as the included angle between the axis of the fuel oil injection hole 10 and the central axis increases, the distance between the fuel oil beam and the gaseous fuel beam decreases so that the gaseous fuel can be ignited more quickly. During this process, the injection penetration distance of the fuel oil increases. Moreover, when the included angle between the axis of the fuel oil injection hole 10 and the central axis increases to a certain extent, the fuel oil is injected outside the combustion chamber pit, leading to a slower ignition speed and incomplete combustion. Therefore, referring to FIG. 7, assuming that the included angle between the axis of the fuel oil injection hole 10 and the central axis is θ, then 10°≤θ≤45°, that is, the adjustment range of the included angle between the axis of the fuel oil injection hole 10 and the central axis is 10° to 45°, thereby satisfying the requirements of combustion chambers 4 of different structures while taking into account the penetration distance of the fuel oil and the distance between the fuel oil beam and the gaseous fuel beam.

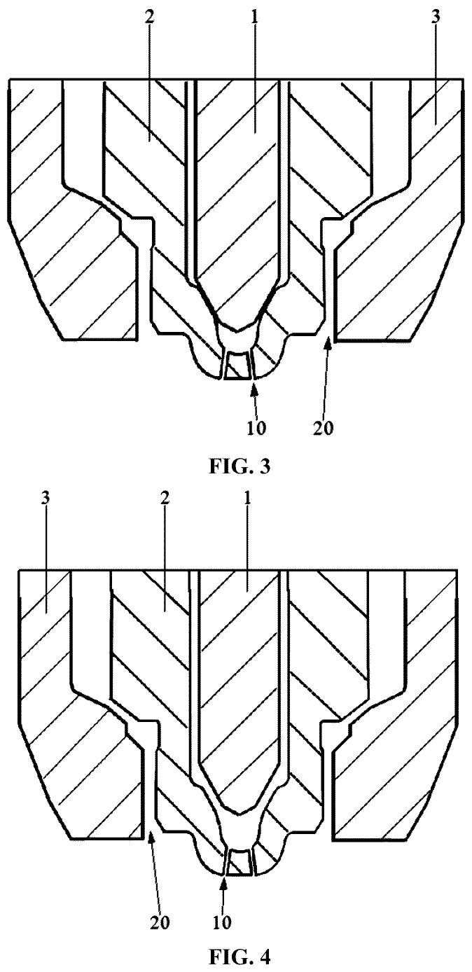

The present disclosure provides a control method for a dual fuel injector 100, which is applied to the dual fuel injector 100 in this embodiment to control the fuel oil injection and/or gaseous fuel injection of the dual fuel injector 100. The dual fuel injector 100 has four states, namely, a closed state, a fuel oil injection state, a gaseous fuel injection state, and a state in which fuel oil and gaseous fuel are injected simultaneously. When the dual fuel injector 100 is in the closed state, as shown in FIG. 1, the fuel oil injection valve core 1 is partially in contact with the fuel oil injection valve seat 2, and the fuel oil injection channel 30 is closed; the fuel oil injection valve seat 2 is partially in contact with the gaseous fuel injection valve seat 3, and the gaseous fuel injection channel 20 is closed, so that neither fuel oil nor gaseous fuel is injected. This state is applicable to the control of other strokes of the engine except the intake stroke. The fuel oil injection state, the gaseous fuel injection state, and the state in which fuel oil and gaseous fuel are injected simultaneously of the dual fuel injector 100 are all applicable to the control of the intake stroke of the engine. When the dual fuel injector 100 is in the fuel oil injection state, as shown in FIG. 2, a certain gap is maintained between the fuel oil injection valve core 1 and the fuel oil injection valve seat 2, and the fuel oil injection channel 30 is opened; the fuel oil injection valve seat 2 is partially in contact with the gaseous fuel injection valve seat 3, and the gaseous fuel injection channel 20 is closed, so that only fuel oil is injected. This is suitable for emergency operation of the engine after the gaseous fuel is exhausted. Similarly, when the dual fuel injector 100 is in the gaseous fuel injection state, as shown in FIG. 3, the fuel oil injection valve core 1 is partially in contact with the fuel oil injection valve seat 2, and the fuel oil injection channel 30 is closed; a certain gap is maintained between the fuel oil injection valve seat 2 and the gaseous fuel injection valve seat 3, and the gaseous fuel injection channel 20 is opened, so that only gaseous fuel is injected. This is suitable for emergency operation of the engine after the fuel oil is exhausted. The simultaneous injection of fuel oil and gaseous fuel is the normal working state of the dual fuel injector 100. Referring to FIG. 4, a certain gap is maintained between the fuel oil injection valve core 1 and the fuel oil injection valve seat 2, and the fuel oil injection channel 30 is opened; a certain gap is maintained between the fuel oil injection valve seat 2 and the gaseous fuel injection valve seat 3, and the gaseous fuel injection channel 20 is opened, so that fuel oil and gaseous fuel are injected simultaneously. In an embodiment, in the state in which fuel oil and gaseous fuel are injected simultaneously, the dual fuel injector 100 is first calibrated so that the calibration results of the movement distance of the fuel oil injection valve seat 2 relative to the gaseous fuel injection valve seat 3 and the gaseous fuel flow rate are acquired, that is, the correspondence between the lift of the fuel oil injection valve seat 2 and the gaseous fuel flow rate is acquired, for example, a relationship curve or a relationship table is acquired.

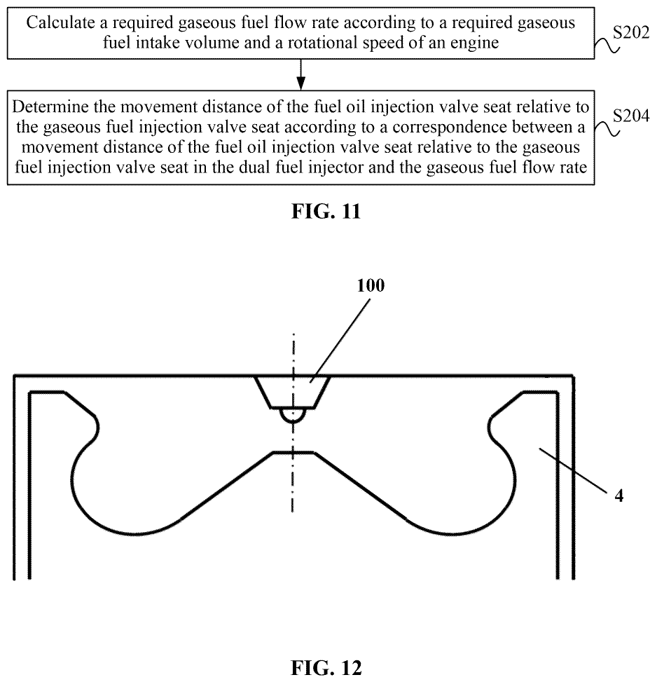

FIG. 11 is a flowchart of an injection control method according to an embodiment of the present disclosure. With reference to FIG. 11, the injection control method for a dual fuel injector 100 includes S202 to S204.

In S202, the required gaseous fuel flow rate is calculated according to the required gaseous fuel intake volume and the rotational speed of the engine.

The required gaseous fuel intake volume is the total amount of supplied gaseous fuel required by the engine under the current working condition. This value is calculated by an engine control unit, which is not described in detail here. The duration during which the gaseous fuel injection channel 20 is opened is determined through the rotational speed of the engine so that the required gaseous fuel flow rate is obtained through the required total amount of supplied gaseous fuel and the duration during which the gaseous fuel injection channel 20 is opened. In this process, compensation is able to be made during the design of valve timing according to the response time for the opening and closing of the gaseous fuel injection channel 20, thereby ensuring the accuracy of the final injection amount.

In S204, according to the correspondence between the movement distance of the fuel oil injection valve seat 2 relative to the gaseous fuel injection valve seat 3 in the dual fuel injector 100 and the gaseous fuel flow rate, the movement distance of the fuel oil injection valve seat 2 relative to the gaseous fuel injection valve seat 3 is determined, that is, the lift of the fuel oil injection valve seat 2 is determined.

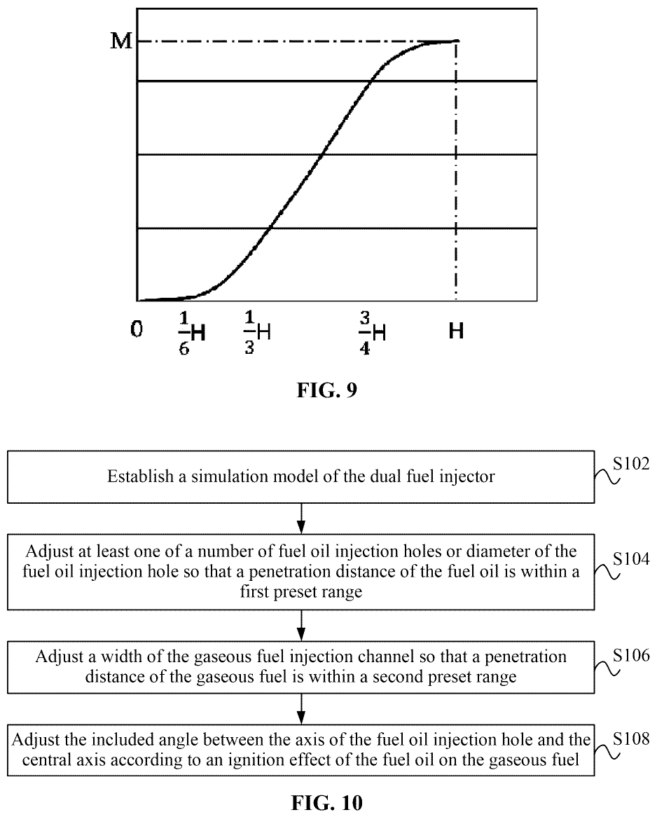

The relationship curve between the lift of the fuel oil injection valve seat 2 and the gaseous fuel flow rate in this embodiment is shown in FIG. 9, the abscissa represents the lift of the fuel oil injection valve seat 2, and the ordinate represents the gaseous fuel flow rate. Since the width of the regulation cavity 22 is determined by the lifting and lowering of the fuel oil injection valve seat 2 relative to the gaseous fuel injection valve seat 3, the closing and opening of the gaseous fuel injection channel 20 are achieved by the contact and separation of the inclined surface structures of the fuel oil injection valve seat 2 and the gaseous fuel injection valve seat 3. When the lift of the fuel oil injection valve seat 2 is relatively small, the width of the regulation cavity 22 is relatively small. In this case, due to the arrangement of the inclined surface structures and the pressure stabilization cavity 23, the flow of gaseous fuel is significantly obstructed. Therefore, in this stage, as the opening degree of the fuel oil injection valve seat 2 increases, the increase in the gaseous fuel flow rate is not significant. For details, reference is made to the 0-⅙H stage of the curve in FIG. 9. As the opening degree of the fuel oil injection valve seat 2 increases, the width of the regulation cavity 22 increases synchronously. In this case, the resistance to the flow of gaseous fuel by the inclined surface structures and the pressure stabilization cavity 23 decreases. Therefore, as the opening degree of the fuel oil injection valve seat 2 increases, the rate of increase of the gaseous fuel flow rate gradually increases, that is, the slope of the curve in the ⅙H-⅓H stage of the curve in FIG. 9 gradually increases. As the opening degree of the fuel oil injection valve seat 2 continues increasing, the width of the regulation cavity 22 increases synchronously. In this case, the resistance to the flow of gaseous fuel by the inclined surface structures and the pressure stabilization cavity 23 is relatively weak, and the gaseous fuel flow rate is positively correlated with the opening degree of the fuel oil injection valve seat 2, which corresponds to the ⅓H-¾H stage of the curve in FIG. 9. Moreover, in this stage, the requirements for the gaseous fuel flow rate under various working conditions can basically be satisfied, and the fuel oil injection valve seat 2 can be easily linearly controlled. The dual fuel injector 100 in this embodiment has a wide linear control range and covers a large range of the gaseous fuel flow rate, which is conducive to more accurate control of the gaseous fuel flow rate. Finally, as the opening degree of the fuel oil injection valve seat 2 further increases, the opening degree of the fuel oil injection valve seat 2 is no longer positively correlated with the gaseous fuel flow rate. Instead, while the gaseous fuel flow rate increases slowly, the pressure in the pressure stabilization cavity 23 increases, ultimately increasing the speed of the gaseous fuel at the injection section 243 of the gaseous fuel injection cavity 24 and thus enabling the gaseous fuel to enter the combustion chamber 4 more quickly. This stage is suitable for extreme working conditions such as rapid acceleration, ensuring rapid injection of gaseous fuel in a short period and thus improving the power response speed of the engine under the rapid acceleration condition.

In the injection control method for a dual fuel injector 100 in this embodiment, the dual fuel injector 100 is calibrated, the required gaseous fuel flow rate is calculated according to the required gaseous fuel intake volume and the rotational speed of the engine, and the lift of the fuel oil injection valve seat 2 is determined according to the calibration results so that the gaseous fuel injection response is faster and the injection control accuracy is higher.

Apparently, the preceding embodiments of the present disclosure are illustrative examples of the present disclosure and are not intended to limit the implementations of the present disclosure. Those of ordinary skill in the art can make changes or variations in other different forms based on the preceding description. All embodiments do not need to be and cannot be exhausted herein. Any modifications, equivalent substitutions, and improvements made within the spirit and principle of the present disclosure fall within the scope of the claims of the present disclosure.

What is claimed is:

1. A dual fuel injector, comprising a fuel oil injection valve core, a fuel oil injection valve seat, and a gaseous fuel injection valve seat;
wherein the fuel oil injection valve seat is provided with a fuel oil injection channel, the fuel oil injection valve core is disposed in the fuel oil injection channel, the fuel oil injection valve core is movable relative to the fuel oil injection valve seat to open or close the fuel oil injection channel, the fuel oil injection valve seat is provided with a fuel oil injection hole, and the fuel oil injection hole is in communication with the fuel oil injection channel and is used for injecting fuel oil into a combustion chamber;
the gaseous fuel injection valve seat is sleeved outside the fuel oil injection valve seat, a gaseous fuel injection channel is formed between the fuel oil injection valve seat and the gaseous fuel injection valve seat, the gaseous fuel injection channel comprises a regulation cavity and a gaseous fuel injection cavity, an opening degree of the regulation cavity increases or decreases as the fuel oil injection valve seat rises or falls relative to the gaseous fuel injection valve seat, and the gaseous fuel injection cavity is used for injecting gaseous fuel into the combustion chamber; and
an axis of the fuel oil injection hole is set at an included angle to a central axis of the dual fuel injector, and along a flow direction of the gaseous fuel, an extension direction of the gaseous fuel injection cavity is parallel to the central axis or inclined toward the central axis.

2. The dual fuel injector of claim 1, wherein the gaseous fuel injection channel further comprises a pressure stabilization cavity, and the regulation cavity is in communication with the gaseous fuel injection cavity through the pressure stabilization cavity.

3. The dual fuel injector of claim 2, wherein a maximum width of the regulation cavity is greater than or equal to a width of the gaseous fuel injection cavity.

4. The dual fuel injector of claim 2, wherein along a direction of the central axis, a length of the gaseous fuel injection cavity is greater than a length of the pressure stabilization cavity, and the length of the pressure stabilization cavity is greater than a length of the regulation cavity.

5. The dual fuel injector of claim 2, wherein along the flow direction of the gaseous fuel, the gaseous fuel injection cavity is provided with an inlet section, an acceleration section, and an injection section in sequence, the inlet section has a bell-mouth structure, a large end of the inlet section is in communication with the pressure stabilization cavity, the acceleration section is in communication with a small end of the inlet section, a side of the injection section on the gaseous fuel injection valve seat is configured to be a straight wall, a side of the injection section on the fuel oil injection valve seat is configured to be an inclined wall, and the inclined wall is inclined toward the central axis.

6. The dual fuel injector of claim 5, wherein an included angle between the inclined wall of the injection section on the fuel oil injection valve seat and a horizontal direction is less than 60°.

7. The dual fuel injector of claim 5, wherein a side of the pressure stabilization cavity on the fuel oil injection valve seat is configured to be a straight wall, an upper section of a side of the pressure stabilization cavity on the gaseous fuel injection valve seat is configured to be a straight wall, a lower section of the side of the pressure stabilization cavity on the gaseous fuel injection valve seat is configured to be an inclined wall and extends downward to form an inclined wall of the inlet section on the gaseous fuel injection valve seat, and an included angle between an inclined wall of the inlet section on the fuel oil injection valve seat and a horizontal direction is greater than an included angle between the inclined wall of the inlet section on the gaseous fuel injection valve seat and the horizontal direction.

8. The dual fuel injector of claim 7, wherein the included angle between the inclined wall of the inlet section on the fuel oil injection valve seat and the horizontal direction is greater than or equal to 45° and less than or equal to 60°, and the included angle between the inclined wall of the inlet section on the gaseous fuel injection valve seat and the horizontal direction is greater than or equal to 45° and less than or equal to 60°.

9. A design method for a dual fuel injector, configured to perform a structural design on the dual fuel injector, wherein the dual fuel injector comprises a fuel oil injection valve core, a fuel oil injection valve seat, and a gaseous fuel injection valve seat;
the fuel oil injection valve seat is provided with a fuel oil injection channel, the fuel oil injection valve core is disposed in the fuel oil injection channel, the fuel oil injection valve core is movable relative to the fuel oil injection valve seat to open or close the fuel oil injection channel, the fuel oil injection valve seat is provided with a fuel oil injection hole, and the fuel oil injection hole is in communication with the fuel oil injection channel and is used for injecting fuel oil into a combustion chamber;
the gaseous fuel injection valve seat is sleeved outside the fuel oil injection valve seat, a gaseous fuel injection channel is formed between the fuel oil injection valve seat and the gaseous fuel injection valve seat, the gaseous fuel injection channel comprises a regulation cavity and a gaseous fuel injection cavity, an opening degree of the regulation cavity increases or decreases as the fuel oil injection valve seat rises or falls relative to the gaseous fuel injection valve seat, and the gaseous fuel injection cavity is used for injecting gaseous fuel into the combustion chamber;
an axis of the fuel oil injection hole is set at an included angle to a central axis of the dual fuel injector, and along a flow direction of the gaseous fuel, an extension direction of the gaseous fuel injection cavity is parallel to the central axis or inclined toward the central axis; and
wherein the design method for a dual fuel injector comprises:
establishing a simulation model of the dual fuel injector;
adjusting at least one of a number of fuel oil injection holes or a diameter of the fuel oil injection hole so that a penetration distance of the fuel oil is within a first preset range;
adjusting a width of the gaseous fuel injection channel so that a penetration distance of the gaseous fuel is within a second preset range; and
adjusting the included angle between the axis of the fuel oil injection hole and the central axis according to an ignition effect of the fuel oil on the gaseous fuel.

10. The design method for a dual fuel injector of claim 9, wherein
a method for adjusting at least one of the number of the fuel oil injection holes or the diameter of the fuel oil injection hole comprises:
in response to the penetration distance of the fuel oil being less than a minimum value of the first preset range, reducing at least one of the number of the fuel oil injection holes or the diameter of the fuel oil injection hole until the penetration distance of the fuel oil is within the first preset range; and
in response to the penetration distance of the fuel oil being greater than a maximum value of the first preset range, increasing at least one of the number of the fuel oil injection holes or the diameter of the fuel oil injection hole until the penetration distance of the fuel oil is within the first preset range;
wherein a method for adjusting the width of the gaseous fuel injection channel comprises:
in response to the penetration distance of the gaseous fuel being less than a minimum value of the second preset range, reducing the width of the gaseous fuel injection channel until the penetration distance of the gaseous fuel is within the second preset range; and
in response to the penetration distance of the gaseous fuel being greater than a maximum value of the second preset range, increasing the width of the gaseous fuel injection channel until the penetration distance of the gaseous fuel is within the second preset range.

11. The design method for a dual fuel injector of claim 9, wherein an adjustment range of the included angle between the axis of the fuel oil injection hole and the central axis is 10° to 45°.

12. The design method for a dual fuel injector of claim 9, wherein the gaseous fuel injection channel further comprises a pressure stabilization cavity, and the regulation cavity is in communication with the gaseous fuel injection cavity through the pressure stabilization cavity.

13. The design method for a dual fuel injector of claim 12, wherein a maximum width of the regulation cavity is greater than or equal to a width of the gaseous fuel injection cavity.

14. The design method for a dual fuel injector of claim 12, wherein along a direction of the central axis, a length of the gaseous fuel injection cavity is greater than a length of the pressure stabilization cavity, and the length of the pressure stabilization cavity is greater than a length of the regulation cavity.

15. The design method for a dual fuel injector of claim 12, wherein along the flow direction of the gaseous fuel, the gaseous fuel injection cavity is provided with an inlet section, an acceleration section, and an injection section in sequence, the inlet section has a bell-mouth structure, a large end of the inlet section is in communication with the pressure stabilization cavity, the acceleration section is in communication with a small end of the inlet section, a side of the injection section on the gaseous fuel injection valve seat is configured to be a straight wall, a side of the injection section on the fuel oil injection valve seat is configured to be an inclined wall, and the inclined wall is inclined toward the central axis.

16. The design method for a dual fuel injector of claim 15, wherein an included angle between the inclined wall of the injection section on the fuel oil injection valve seat and a horizontal direction is less than 60°.

17. The design method for a dual fuel injector of claim 15, wherein a side of the pressure stabilization cavity on the fuel oil injection valve seat is configured to be a straight wall, an upper section of a side of the pressure stabilization cavity on the gaseous fuel injection valve seat is configured to be a straight wall, a lower section of the side of the pressure stabilization cavity on the gaseous fuel injection valve seat is configured to be an inclined wall and extends downward to form an inclined wall of the inlet section on the gaseous fuel injection valve seat, and an included angle between an inclined wall of the inlet section on the fuel oil injection valve seat and a horizontal direction is greater than an included angle between the inclined wall of the inlet section on the gaseous fuel injection valve seat and the horizontal direction.

18. The design method for a dual fuel injector of claim 17, wherein the included angle between the inclined wall of the inlet section on the fuel oil injection valve seat and the horizontal direction is greater than or equal to 45° and less than or equal to 60°, and the included angle between the inclined wall of the inlet section on the gaseous fuel injection valve seat and the horizontal direction is greater than or equal to 45° and less than or equal to 60°.

19. An injection control method for a dual fuel injector, applied to the dual fuel injector, wherein the dual fuel injector comprises a fuel oil injection valve core, a fuel oil injection valve seat, and a gaseous fuel injection valve seat;
the fuel oil injection valve seat is provided with a fuel oil injection channel, the fuel oil injection valve core is disposed in the fuel oil injection channel, the fuel oil injection valve core is movable relative to the fuel oil injection valve seat to open or close the fuel oil injection channel, the fuel oil injection valve seat is provided with a fuel oil injection hole, and the fuel oil injection hole is in communication with the fuel oil injection channel and is used for injecting fuel oil into a combustion chamber;
the gaseous fuel injection valve seat is sleeved outside the fuel oil injection valve seat, a gaseous fuel injection channel is formed between the fuel oil injection valve seat and the gaseous fuel injection valve seat, the gaseous fuel injection channel comprises a regulation cavity and a gaseous fuel injection cavity, an opening degree of the regulation cavity increases or decreases as the fuel oil injection valve seat rises or falls relative to the gaseous fuel injection valve seat, and the gaseous fuel injection cavity is used for injecting gaseous fuel into the combustion chamber;
an axis of the fuel oil injection hole is set at an included angle to a central axis of the dual fuel injector, and along a flow direction of the gaseous fuel, an extension direction of the gaseous fuel injection cavity is parallel to the central axis or inclined toward the central axis; and
wherein the injection control method for a dual fuel injector comprises:
calculating a required gaseous fuel flow rate according to a required gaseous fuel intake volume and a rotational speed of an engine; and
determining, according to a correspondence between a movement distance of the fuel oil injection valve seat relative to the gaseous fuel injection valve seat in the dual fuel injector and the gaseous fuel flow rate, the movement distance of the fuel oil injection valve seat relative to the gaseous fuel injection valve seat.

20. The injection control method for a dual fuel injector of claim 19, wherein the gaseous fuel injection channel further comprises a pressure stabilization cavity, and the regulation cavity is in communication with the gaseous fuel injection cavity through the pressure stabilization cavity.
